(19) United States
(12) Patent Application Publication
(10) Pub. No.: US 2024/0296642 A1
(43) Pub. Date: Sep. 5, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: DAISUKE TAJIMA, TOKYO (JP); HIROMU YUMIBA, TOKYO (JP); MIWA ICHIKAWA, TOKYO (JP); TOMOHIRO ISHII, TOKYO (JP)

(21) Appl. No.: 18/572,293

(22) PCT Filed: Jan. 28, 2022
(86) PCT No.: PCT/JP2022/003201

§ 371 Date: Dec. 20, 2023

(30) Foreign Application Priority Data
Jun. 29, 2021 (JP) 2021-108085

(51) Int. Cl. G06T 19/20; G06T 5/50; G06T 7/70; G06T 13/40

(52) U.S. Cl. CPC G06T 19/20; G06T 5/50; G06T 7/70; G06T 13/40; G06T 2207/20221; G06T 2219/2004; G06T 2219/2016

(57) ABSTRACT

An information processing apparatus including an acquisition unit that acquires first posture information indicating positions and postures of one or more first users each wearing a first terminal device, and second posture information indicating positions and postures of one or more second users each wearing a second terminal device, a storage unit that stores motion data indicating a change in posture of each user, a processing unit that arranges first avatars of the one or more first users in a virtual space based on the first posture information, arranges second avatars of the one or more second users in the virtual space based on the second posture information, and arranges a reproduction avatar being changeable in position and direction and reproducing the motion data in the virtual space, and an output unit that causes the first terminal device to display the second avatar and the reproduction avatar according to positions in the virtual space, and causes the second terminal device to display the first avatar and the reproduction avatar according to positions in the virtual space.

### FIELD

The present invention relates to an information processing apparatus, an information processing method, and a program.

### BACKGROUND

An information processing system disclosed in, for example, Patent Literature 1 is known as an information processing system that uses the motion of hands as a model for a user, as a virtual object and makes the user simultaneously visually recognize a real object in a real space and a virtual object. In this information processing system, the virtual object is displayed so as to be overlaid on a real space, for example, on a see-through head mounted display.

### CITATION LIST

### Patent Literature

Patent Literature 1: WO 2017/030193 A

### SUMMARY

### Technical Problem

According to the conventional information system, for example, an instructor is allowed to support work of a worker positioned at a remote location by using the virtual object. However, the conventional information system displays a first person view of the virtual object as a model, with the position of the point of view fixed to the virtual object, making it difficult to understand the motion of the virtual object in some cases. If the motion that is difficult to understand is to be explained by conversation, the instructor and the worker who are not at the same place require a specific and detailed explanation, and the efficiency of assistance is reduced.

Therefore, the present disclosure proposes an information processing apparatus, an information processing method, and a program that are operable to suppress a decrease in support efficiency for a worker.

### Solution to Problem

According to the present disclosure, an information processing apparatus is provided that includes: an acquisition unit that acquires first posture information indicating positions and postures of one or more first users each wearing a first terminal device, and second posture information indicating positions and postures of one or more second users each wearing a second terminal device; a storage unit that stores motion data indicating a change in posture of each user; a processing unit that arranges first avatars of the one or more first users in a virtual space based on the first posture information, arranges second avatars of the one or more second users in the virtual space based on the second posture information, and arranges a reproduction avatar being changeable in position and direction and reproducing the motion data in the virtual space; and an output unit that causes the first terminal device to display the second avatar and the reproduction avatar according to positions in the virtual space, and causes the second terminal device to display the first avatar and the reproduction avatar according to positions in the virtual space. Moreover, according to the present disclosure, an information processing method for causing a computer to perform information processing of the information processing apparatus, and a program that causes a computer to perform information processing of the information processing apparatus are provided.

### BRIEF DESCRIPTION OF DRAWINGS

FIG. 1 is a diagram illustrating an apparatus and devices constituting an information processing system according to an embodiment.

FIG. 2 is a diagram illustrating an example of a farm field and avatars visually recognized by a worker.

FIG. 3 is a diagram illustrating an example of a 3D map and avatars visually recognized by an instructor.

FIG. 4 is a diagram illustrating a tap operation as a trigger for the start and finish of recording the motion of the instructor.

FIG. 5 is a diagram illustrating an operation to change the position and direction of a reproduction avatar.

FIG. 6 is a block diagram illustrating a functional configuration of an information processing apparatus 10.

FIG. 7 is a block diagram illustrating a hardware configuration and functional configuration of a first terminal device.

FIG. 8 is a block diagram illustrating a hardware configuration and functional configuration of a second terminal device.

FIG. 9 is a state transition diagram of the first terminal device recording the motion of a user thereof.

FIG. 10 is a flowchart illustrating a process of detecting the tap operation.

FIG. 11 is a flowchart illustrating a process of recording the motion of the user.

FIG. 12 is a state transition diagram related to moving of the reproduction avatar.

FIG. 13 is a flowchart illustrating a process in changing an access privilege to the reproduction avatar.

FIG. 14 is a flowchart illustrating a process of moving the reproduction avatar AV3.

FIG. 15 is an exemplary hardware configuration diagram of a computer implementing the functions of the information processing apparatus.

### DESCRIPTION OF EMBODIMENTS

Preferred embodiments of the present disclosure will be described in detail below with reference to the accompanying drawings. Note that in the present specification and the drawings, component elements having substantially the same functional configurations are denoted by the same reference numerals, and redundant descriptions thereof will be omitted.

Note that the description will be given in the following order.
1. Overview of embodiment of present disclosure
1.1. Introduction
1.2. Overview of information processing system
2. Example of information processing system
2.1. Display of avatar
2.2. Record of motion of instructor
2.3. Reproduction of motion of instructor
2.4. Moving reproduction avatar
3. Configuration of information processing system
3.1. Configuration of information processing apparatus
3.2. Configuration of first terminal device
3.3. Configuration of second terminal device
3.4. Process in information processing system
3.5. Variations of processing
4. Exemplary hardware configuration
5. Conclusion

### 1. OVERVIEW OF EMBODIMENT OF PRESENT DISCLOSURE

### 1.1. Introduction

In Synecoculture (registered trademark), attention has been paid to a technology of remote assistance for a worker working in a farm field by an instructor from a remote location, by using an XR technology. In the remote assistance, for example, if the motion of the hands of the instructor in agricultural work performed in the farm field is recorded and the recorded motion is reproduced by using an avatar, in front of the worker, the recorded motion of the hands can be provided as content, for further efficient remote assistance for the worker.

However, if the point of view of the worker is fixed on the avatar reproducing the recorded motion, the motion of the avatar can only be viewed from a predetermined direction, and the assistance to the work may be hindered.

Therefore, the present disclosure proposes an information processing apparatus, an information processing method, and a program that are operable to efficiently perform remote assistance.

In the following description, a person who works in the farm field is appropriately referred to as “worker”, and a person who assists the worker in a remote location or the farm field is appropriately referred to as “instructor”. The worker visually recognizes information displayed by augmented reality (AR) or mixed reality (MR), in the farm field. In assistance in the farm field, the instructor visually recognizes information displayed in AR or MR, and visually recognizes the farm field and information displayed in virtual reality (VR) upon assistance from the remote location.

### 1.2. Overview of Information Processing System

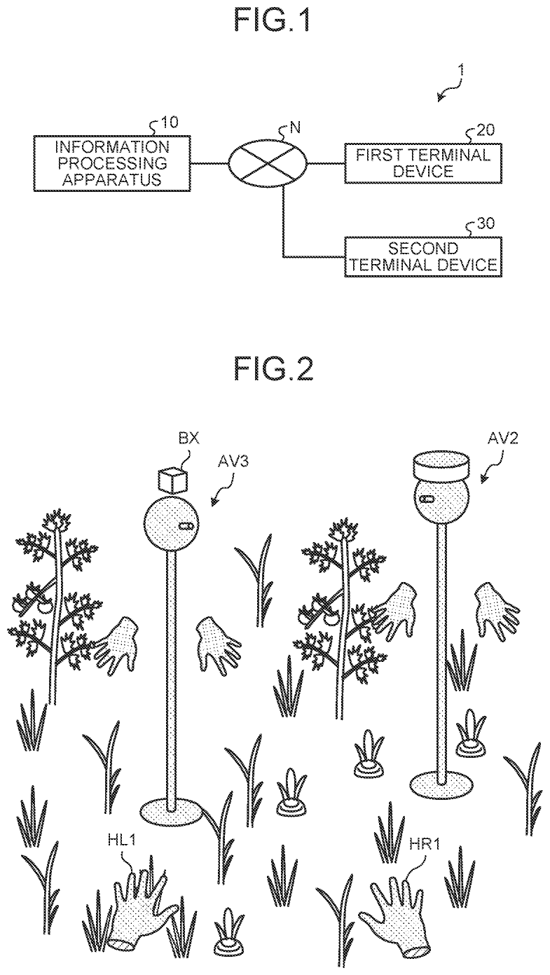

An overview of an information processing system 1 according to the embodiment will be described. FIG. 1 is a diagram illustrating an apparatus and devices constituting the information processing system 1. As illustrated in FIG. 1, the information processing system 1 includes an information processing apparatus 10, a first terminal device 20, and a second terminal device 30. For example, the information processing apparatus 10 is wiredly connected to a communication network N, but may be connected wirelessly. Various devices can be connected to the information processing apparatus 10. The first terminal device 20 and the second terminal device 30 are connected to the information processing apparatus 10 via the communication network N so that information is shared between the apparatus and the devices. Furthermore, the first terminal device 20 and the second terminal device 30 are wiredly or wirelessly connected to the communication network N as well. The wireless connection of the first terminal device 20 and second terminal device 30 to the communication network N is, for example, connection via a wireless LAN, but is not limited to the wireless LAN, and may be, for example, connection using Bluetooth (registered trademark).

The first terminal device 20 is, for example, an optical see-through head mounted display, such as HoloLens (registered trademark) or Hololens2, usable for display in AR. Furthermore, the first terminal device 20 may be a terminal device, such as a smartphone, usable for display in AR using ARCore (registered trademark), ARKit (registered trademark), or the like. Furthermore, the first terminal device 20 may be a video see-through AR device or XR device such as Varjo (registered trademark) XR-1. The first terminal device 20 is worn by the worker or the instructor. For example, the first terminal device 20 receives avatar information, which is described later, from the information processing apparatus 10, and displays an avatar in AR on the basis of the received information. The first terminal device 20 includes a sensor, and transmits information indicating a position and inclination of the head of a user thereof, a facing direction thereof, the position of each hand of the user, and the posture of the hand, which are sensed by the sensor, to the information processing apparatus 10 in real time, as first posture information. Furthermore, the first terminal device 20 senses and records the position and posture of the hand of the user and the position and posture of the head of the user according to the operation of the user, and transmits motion data indicating the position and posture of the hand of the user recorded and the position and posture of the head of the user recorded, to the information processing apparatus 10.

The second terminal device 30 is a head mounted display usable for display in VR. Furthermore, the second terminal device 30 may be a terminal device such as a smartphone usable for display in VR. The second terminal device 30 is worn by the instructor. The second terminal device 30 receives, for example, map information and avatar information, which are described later, from the information processing apparatus 10, and displays the farm field in VR and displays an avatar in VR, on the basis of the received information. Furthermore, the second terminal device 30 includes a sensor, and transmits information indicating a position and inclination of the head of a user thereof, a facing direction thereof, the position of each hand of the user, and the posture of the hand, which are sensed by the sensor, to the information processing apparatus 10 in real time, as second posture information.

Note that the first terminal device 20 and the second terminal device 30 are connected to the communication network N and the information are provided thereto from the information processing apparatus 10. However, the number of the first terminal devices 20 and the number of the second terminal devices 30 are not limited to one, respectively, and a plurality of the first terminal devices 20 and a plurality of the second terminal devices 30 are allowed to be connected to the communication network N so that display in AR and display in VR can be performed on the basis of the information provided from the information processing apparatus 10.

The information processing apparatus 10 is an information processing apparatus that performs processing for providing information to be displayed in AR to the first terminal device 20, and processing for providing information to be displayed in VR to the second terminal device 30. The information processing apparatus 10 stores a 3D map of the farm field that is generated by sensing the farm field in advance by, for example, light detection and ranging (LiDAR), and transmits the map information indicating the stored 3D map to the second terminal device 30. The information processing apparatus 10 receives and stores the motion data transmitted from the first terminal device 20. The information processing apparatus 10 transmits reproduction avatar information indicating an avatar to be reproduced from the stored motion data, to each of the first terminal device 20 and the second terminal device 30. The information processing apparatus 10 receives the first posture information transmitted from the first terminal device 20 in real time and the second posture information transmitted from the second terminal device 30 in real time. The information processing apparatus 10 transmits first avatar information indicating an avatar of the user of the first terminal device 20 to the second terminal device 30, on the basis of the first posture information transmitted in real time from the first terminal device 20. The information processing apparatus 10 transmits second avatar information indicating an avatar of the user of the second terminal device 30 to the first terminal device 20, on the basis of the second posture information transmitted from the second terminal device 30 in real time. The information processing apparatus 10 is implemented by PC, WS, or the like. Note that the information processing apparatus 10 is not limited to the PC, WS, or the like. For example, the information processing apparatus 10 may be an information processing apparatus such as PC or WS in which a function as the information processing apparatus 10 is implemented as an application.

### 2. EXAMPLE OF INFORMATION PROCESSING SYSTEM

Next, an example of the information processing system 1 will be described.

### 2.1. Display of Avatars

FIG. 2 is a diagram illustrating an example of the farm field visually recognized by the worker wearing the first terminal device 20 via the first terminal device 20, and avatars that are displayed in AR on the first terminal device 20 and visually recognized by the worker. The worker is an example of a first user who wears the first terminal device 20. As illustrated in FIG. 2, various plants are planted in the farm field where the worker works. The display in AR visually recognized by the worker includes a second avatar AV2 that is an avatar of the instructor positioned at a remote location and wearing the second terminal device 30, and a reproduction avatar AV3 that reproduces the motion data. The worker can view the real-time motion of the instructor by the displayed second avatar AV2. Furthermore, the display in AR visually recognized by the worker wearing the first terminal device 20 includes a virtual hand HL1 that is a virtual object visualizing a left hand of the worker sensed by the first terminal device 20, and a virtual hand HR1 that is a virtual object visualizing a right hand of the worker sensed by the first terminal device 20. The second avatar AV2 is displayed at a position corresponding to a position where the instructor is located, in a virtual space indicated by the 3D map of the farm field described above. The reproduction avatar AV3 is displayed at a position corresponding to a position specified by the instructor wearing the second terminal device 30, in the virtual space indicated by the 3D map of the farm field.

FIG. 3 is a diagram illustrating an example of the 3D map of the farm field displayed in VR on the second terminal device 30 and visually recognized by the instructor wearing the second terminal device 30, and avatars displayed in VR on the second terminal device 30 and visually recognized by the instructor. The instructor is an example of a second user wearing the second terminal device 30. The origin of the virtual space indicated by the 3D map displayed on the second terminal device 30 coincides with the origin defined in the farm field where the worker is located, and the instructor can share the space where the worker is located, on the 3D map. The display in VR visually recognized by the instructor includes a first avatar AV1 that is an avatar of the worker positioned in the farm field and wearing the first terminal device 20, and the reproduction avatar AV3 that reproduces the motion data. The instructor can view the real-time motion of the worker by the displayed first avatar AV1. Furthermore, the display in VR visually recognized by the instructor wearing the second terminal device 30 includes a virtual hand HL2 that is a virtual object visualizing a left hand of the instructor sensed by the second terminal device 30 and a virtual hand HR2 that is a virtual object visualizing the right hand of the instructor sensed by the second terminal device 30. The first avatar AV1 is displayed at a position corresponding to a position where the worker is located, in the virtual space indicated by the 3D map of the farm field described above. The reproduction avatar AV3 is displayed at a position corresponding to a position specified by the instructor wearing the second terminal device 30, in the virtual space indicated by the 3D map of the farm field.

### 2.2. Record of Motion of Instructor

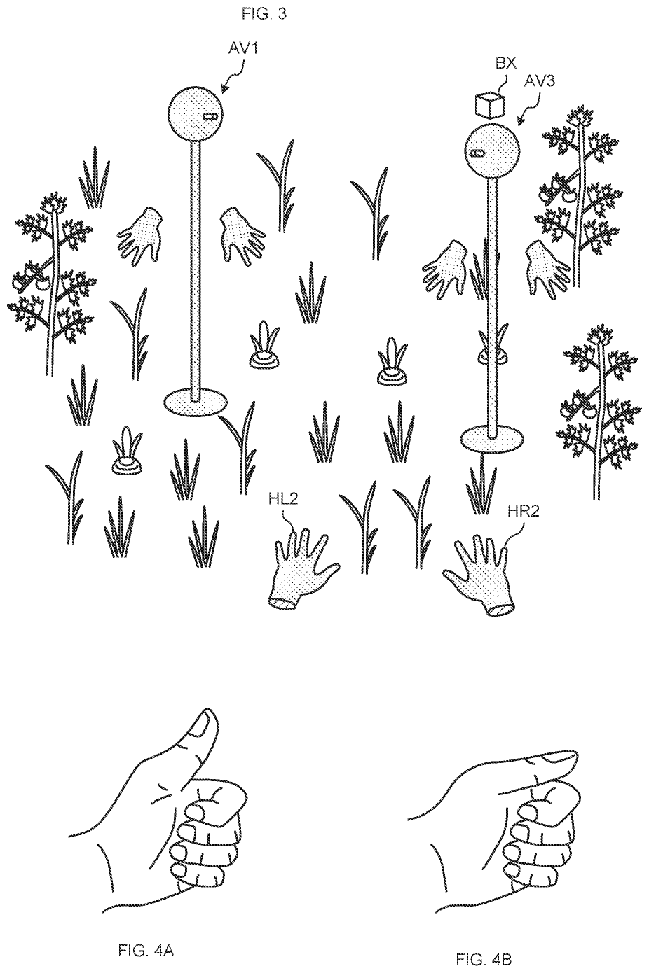

The motion of the instructor to be reproduced by the reproduction avatar AV3 is recorded by the first terminal device 20, for example, based on a predetermined motion of the instructor wearing the first terminal device 20. FIG. 4 is a diagram illustrating a tap operation as a trigger for the start and finish of recording the motion of the instructor. FIG. 4 (a) illustrates a state in which the instructor raises a thumb, and FIG. 4 (b) illustrates a state in which a distance from the tip of the thumb to the second joint of the index finger is equal to or less than a threshold.

The first terminal device 20 senses the posture of a hand of the instructor, and detects the tap operation in which the posture of the hand changes from the state illustrated in FIG. 4 (a) to the state illustrated in FIG. 4 (b) and returns to the state illustrated in FIG. 4 (a). When the first terminal device 20 detects that the tap operation has been performed a predetermined number of times with a period less than a predetermined period, the first terminal device 20 senses the positions and postures of the hands of the instructor, the position and posture of the head of the instructor, and the like, and starts recording data about the sensed positions and postures. In addition, when the first terminal device 20 detects that the tap operation is performed a predetermined number of times with a period less than the predetermined period while recording the data about the positions and postures of the hands of the instructor and the position and posture of the head of the instructor, the first terminal device 20 finishes the recording of the data about the sensed positions and postures, and stores the data about the recorded positions and postures, as the motion data representing the work of the instructor. The first terminal device 20 transmits the stored motion data to the information processing apparatus 10, and the information processing apparatus 10 stores the motion data transmitted from the first terminal device 20. Note that the second terminal device 30 being worn by the instructor in the remote location may sense the positions and postures of the hands of the instructor and the position and posture of the head of the instructor, and transmit data about the sensed positions and postures to the information processing apparatus 10, as the motion data, so that the information processing apparatus 10 stores the data.

### 2.3. Reproduction of Motion of Instructor

The reproduction avatar AV3 displayed on the first terminal device 20 and the second terminal device 30 reproduces the motion data. Specifically, the first terminal device 20 and the second terminal device 30 receive the motion data transmitted from the information processing apparatus 10. The first terminal device 20 and the second terminal device 30 reproduce the position and posture of the head and the positions and postures of the hands, from the start to the end of the recording of the motion data, on the reproduction avatar AV3, through the motion of the reproduction avatar AV3 based on the received data. For example, in a case where the motion of disbudding the plant in the farm field is recorded as the motion data, the reproduction avatar V3 reproduces the motion of disbudding.

### 2.4. Moving Reproduction Avatar

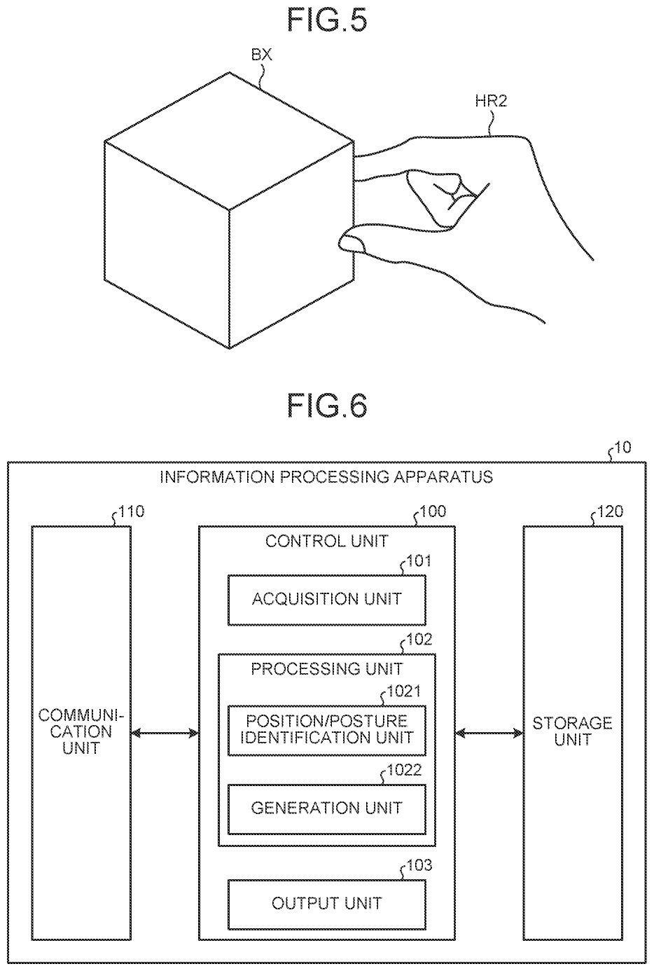

The reproduction avatar AV3 can be changed in position and direction to be displayed, by being operated with the virtual hand HL1, virtual hand HR1, virtual hand HL2, or virtual hand HR2. FIG. 5 is a diagram illustrating an operation to change the position and direction of the reproduction avatar AV3. When the display position of the reproduction avatar V3 is changed, the position of the reproduction avatar AV3 can be changed by operating the reproduction avatar V3 with the virtual hand HL1, virtual hand HR1, virtual hand HL2, or virtual hand HR2. Specifically, for example, when the instructor wearing the second terminal device 30 changes the position of the reproduction avatar V3 in the 3D map viewed on the second terminal device 30, a box BX which is a box-shaped GUI included in the reproduction avatar AV3 is pinched with the virtual hand HR2, as illustrated in FIG. 5, to change the position of the box BX, and the position of the reproduction avatar AV3 is changed to a changed position of the box BX3. Furthermore, changing the direction of the box BX with the virtual hand HR2, the direction of the reproduction avatar AV3 is changed.

### 3. CONFIGURATION OF INFORMATION PROCESSING SYSTEM

Next, a configuration of the information processing system 1 will be described.

### 3.1. Configuration of Information Processing Apparatus

FIG. 6 is a block diagram illustrating a functional configuration of the information processing apparatus 10. As illustrated in FIG. 6, the information processing apparatus 10 includes a control unit 100, a communication unit 110, and a storage unit 120.

The communication unit 110 has a function of communicating with an external device. For example, in communication with the external device, the communication unit 110 outputs information received from the external device to the control unit 100. Specifically, the communication unit 110 supplies information transmitted from the first terminal device 20 and information transmitted from the second terminal device 30 to the control unit 100. Furthermore, the communication unit 110 transmits the information supplied from the control unit 100 to the external device. Specifically, the communication unit 110 acquires the first avatar information indicating the first avatar AV1 generated by the control unit 100 on the basis of the first posture information transmitted from the first terminal device 20, and transmits the acquired first avatar information to the second terminal device 30. Furthermore, the communication unit 110 acquires the second avatar information indicating the second avatar AV2 generated by the control unit 100 on the basis of the second posture information transmitted from the second terminal device 30, and transmits the acquired second avatar information to the first terminal device 20. Furthermore, the communication unit 110 acquires the reproduction avatar information indicating the reproduction avatar AV3 generated by the control unit 100 on the basis of the motion data transmitted from the second terminal device 30, and transmits the acquired reproduction avatar information to the first terminal device 20 and the second terminal device 30. In addition, the communication unit 110 transmits the map information to the second terminal device 30.

The storage unit 120 is implemented by a semiconductor memory device such as RAM or a flash memory, or a storage device such as a hard disk or optical disk. The storage unit 120 has a function of storing information about processing in the information processing apparatus 10. The storage unit 120 stores, for example, the above-described 3D map and the above-described motion data. Note that the 3D map and the motion data stored in the storage unit 120 may be stored in an external storage device connected to the information processing apparatus 10.

The control unit 100 executes processing of controlling the operation of the information processing apparatus 10. For example, the control unit 100 executes processing for providing the first avatar information, the second avatar information, the reproduction avatar information, and the map information. In order to perform the processing, the control unit 100 includes an acquisition unit 101, a processing unit 102, and an output unit 103, as illustrated in FIG. 6

The acquisition unit 101 has a function of acquiring information for generating the first avatar information, second avatar information, reproduction avatar information, and map information. For example, the acquisition unit 101 acquires the first posture information transmitted from the first terminal device 20 via the communication unit 110. In addition, the acquisition unit 101 acquires the second posture information transmitted from the second terminal device 30 via the communication unit 110. In addition, the acquisition unit 101 acquires the motion data and 3D map stored in the storage unit 120.

The processing unit 102 has a function of generating the first avatar information, second avatar information, reproduction avatar information, and map information. As illustrated in FIG. 6, the processing unit 102 includes a position/posture identification unit 1021 and a generation unit 1022.

The position/posture identification unit 1021 identifies the position, inclination, and facing direction of the head of the user wearing the first terminal device 20 in the farm field, and the position and posture of the hand of the user, on the basis of the first posture information. The position/posture identification unit 1021 identifies the position, inclination, and facing direction of the head of the user wearing the second terminal device 30 in the 3D map, and the position and posture of the hand of the user, on the basis of the second posture information. The position/posture identification unit 1021 identifies the stored position and inclination of the head of each user, and position and posture of the hands, on the basis of the motion data. Furthermore, the position/posture identification unit 1021 detects the motion of operating the box BX on the basis of the first posture information or the second posture information, and identifies the position and direction of the reproduction avatar AV3.

The generation unit 1022 generates the first avatar information indicating the first avatar AV1, on the basis of the position, inclination, and facing direction of the head of the user wearing the first terminal device 20, and the position and posture of the hand of the user, which are identified by the position/posture identification unit 1021. The generation unit 1022 generates the second avatar information indicating the second avatar AV2, on the basis of the position, inclination, and facing direction of the head of the user wearing the second terminal device 30, and the position and posture of the hand of the user, which are identified by the position/posture identification unit 1021. The generation unit 1022 generates the reproduction avatar information indicating the reproduction avatar AV3, on the basis of the motion data. The generation unit 1022 generates the map information of the farm field, on the basis of the 3D map. The generation unit 1022 arranges the first avatar AV1, the second avatar AV2, and the reproduction avatar AV3 in the virtual space indicated by the 3D map. The position of the first avatar AV1 arranged in the virtual space is a position corresponding to the position of the user of the first terminal device 20 in the farm field. The position of the second avatar AV2 arranged in the virtual space is a position corresponding to the position of the user of the second terminal device 30 in the virtual space. The position of the reproduction avatar AV3 arranged in the virtual space is a position specified by operating the box BX by the worker or the instructor.

The output unit 103 has a function of outputting the information generated by the generation unit 1022. The output unit 103 outputs the first avatar information, second avatar information, reproduction avatar information, and map information generated by the generation unit 1022, to the communication unit 110.

### 3.2. Configuration of First Terminal Device

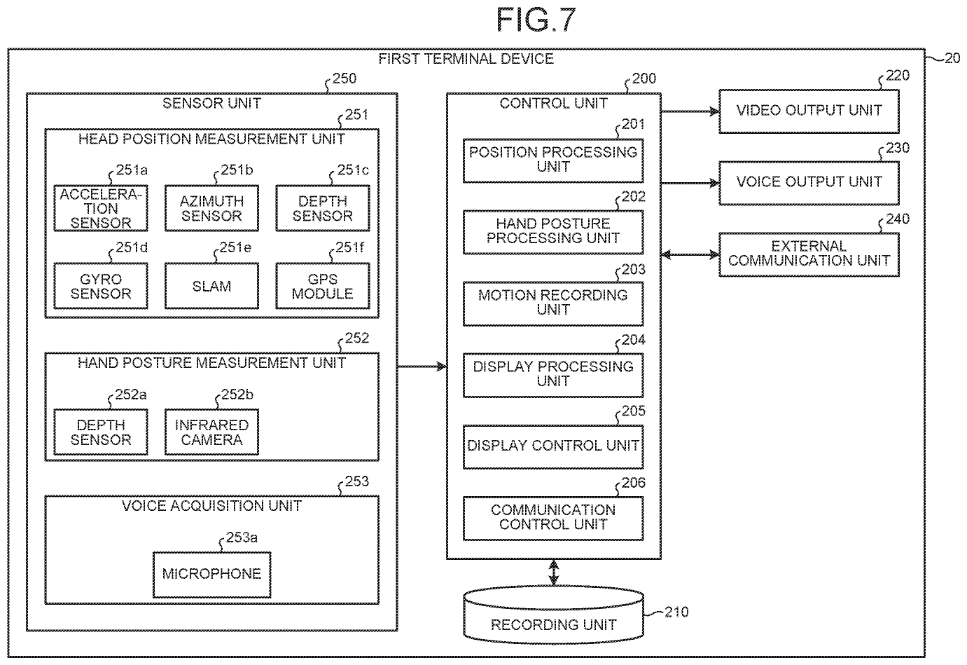

FIG. 7 is a block diagram illustrating a hardware configuration and functional configuration of the first terminal device 20. The first terminal device 20 includes a control unit 200, a storage unit 210, a video output unit 220, a voice output unit 230, an external communication unit 240, and a sensor unit 250.

The sensor unit 250 includes a head position measurement unit 251, a hand posture measurement unit 252, and a voice acquisition unit 253.

The head position measurement unit 251 includes an acceleration sensor 251a, an azimuth sensor 251b, a depth sensor 251c, a gyro sensor 251d, an SLAM 251e, and a GPS module 251f. The acceleration sensor 251a is, for example, a three-axis acceleration sensor. The acceleration sensor 251a outputs acceleration information indicating measured acceleration. The azimuth sensor 251b is a sensor that measures geomagnetism and detects a facing direction of the first terminal device 20. The azimuth sensor 251b outputs direction information indicating the detected direction. The depth sensor 251c is a sensor that measures a distance from the first terminal device 20 to a person or object within a target range. The depth sensor 251c outputs depth information indicating the measured distance. The gyro sensor 251d is a sensor that measures an angular velocity of the first terminal device 20. The gyro sensor 251d outputs angular velocity information indicating the measured angular velocity. The SLAM 251e is, for example, a light detection and ranging (Lidar) simultaneous localization and mapping (SLAM) including a laser scanner or a visual SLAM including a camera. The SLAM 251e senses the surroundings and outputs the map information indicating the surrounding map. The GPS module 251f receives a measured radio wave from a satellite by using a satellite positioning system, and measures the position of the first terminal device 20. The GPS module 251f outputs position information indicating the measured position. The head position measurement unit 251 outputs head information including the acceleration information, direction information, depth information, angular velocity information, map information, and position information.

The hand posture measurement unit 252 includes a depth sensor 252a and an infrared camera 252b. The infrared camera 252b outputs infrared light, receives the infrared light reflected from a hand of the user, and captures an image of the hand of the user. The depth sensor 252a measures a distance to the hand of the user on the basis of the image of the hand of the user generated by the infrared camera 252b. The hand posture measurement unit 252 outputs hand posture information including the measured distance to the hand of the user and the image of the hand of the user.

The voice acquisition unit 253 includes a microphone 253a. The microphone 253a collects sounds around the first terminal device 20 and outputs voice information indicating the collected sounds.

The storage unit 210 is implemented by, for example, a semiconductor memory device such as RAM or a flash memory. The storage unit 210 has a function of storing information about processing in the first terminal device 20. In addition, the storage unit 210 stores an application program performed by the first terminal device 20. The application program stored in the storage unit 210 is, for example, a program that causes the user to visually recognize the second avatar AV2, the reproduction avatar AV3, and the like by using display in AR.

The control unit 200 is implemented by executing an application program stored in the storage unit 210. As illustrated in FIG. 7, the control unit 200 includes a position processing unit 201, a hand posture processing unit 202, a motion recording unit 203, a display processing unit 204, a display control unit 205, and a communication control unit 206.

The position processing unit 201 identifies the position, inclination, facing direction, and the like of the head of the user, on the basis of the head information output from the head position measurement unit 251. The hand posture processing unit 202 identifies the position and posture of the hand of the user, on the basis of the hand posture information output from the hand posture measurement unit 252. For example, when the position of an AR marker set at a predetermined position in the farm field is defined as the origin, the position identified by the position processing unit 201 is identified by a relative position from the origin.

The motion recording unit 203 causes the storage unit 210 to store the head information output from the head position measurement unit 251 and the hand posture information output from the hand posture measurement unit 252, as the motion data.

The display processing unit 204 generates images of the virtual hand HL1 and the virtual hand HR1 on the basis of the positions and postures identified by the hand posture processing unit 202. Furthermore, the display processing unit 204 generates an image to be displayed in AR on the basis of information provided from the information processing apparatus 10. Specifically, the display processing unit 204 generates an image of the second avatar AV2 on the basis of the second avatar information provided from the information processing apparatus 10, and generates an image of the reproduction avatar AV3 on the basis of the reproduction avatar information provided from the information processing apparatus 10.

The display control unit 205 controls the video output unit 220 so that the image of the second avatar AV2 generated by the display processing unit 204 is displayed in AR, and controls the video output unit 220 so that the image of the reproduction avatar AV3 generated by the display processing unit 204 is displayed in AR. The display position of the second avatar AV2 is a position corresponding to the position of the user of the second terminal device 30 in the virtual space indicated by the 3D map. The display position of the reproduction avatar AV3 is a position specified by operating the box BX by the worker or the instructor. In addition, the display control unit 205 controls the video output unit 220 so that the images of the virtual hand HL1 and the virtual hand HR1 are displayed in AR, at the positions of the hands identified by the hand posture processing unit 202.

The communication control unit 206 controls the external communication unit 240 to transmit information to the information processing apparatus 10 and receive information from the information processing apparatus 10.

The video output unit 220 displays, on a half mirror, an AR image output from the control unit 200 to cause the user to visually recognize the AR image. The voice output unit 230 includes a speaker and outputs a sound represented by a voice signal supplied from the external device. The external communication unit 240 has a function of communicating with the external device. For example, in communication with the external device, the external communication unit 240 supplies information received from the external device, to the control unit 200. Specifically, the external communication unit 240 supplies the second avatar information and reproduction avatar information received from the information processing apparatus 10, to the control unit 200. Furthermore, in communication with the external device, the external communication unit 240 transmits information supplied from the control unit 200, to the external device. Specifically, the external communication unit 240 transmits the first posture information including the head information and the hand posture information, to the information processing apparatus 10. Furthermore, the external communication unit 240 transmits the motion data stored in the storage unit 210, to the information processing apparatus 10.

### 3.3. Configuration of Second Terminal Device

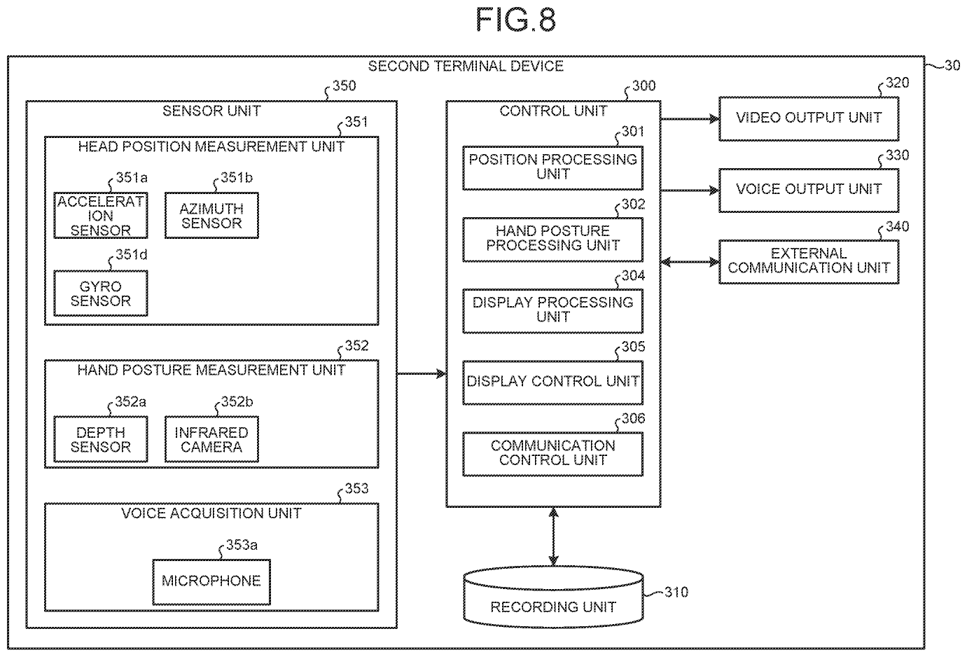

FIG. 8 is a block diagram illustrating a hardware configuration and functional configuration of the second terminal device 30. As illustrated in FIG. 8, the second terminal device 30 includes a control unit 300, a storage unit 310, a video output unit 320, a voice output unit 330, an external communication unit 340, and a sensor unit 350.

The sensor unit 350 includes a head position measurement unit 351, a hand posture measurement unit 352, and a voice acquisition unit 353.

The head position measurement unit 351 includes an acceleration sensor 351a, an azimuth sensor 351b, and a gyro sensor 351d. The acceleration sensor 351a is, for example, a three-axis acceleration sensor, and outputs acceleration information indicating measured acceleration. The azimuth sensor 351b is a sensor that measures geomagnetism and detects a facing direction of the second terminal device 30. The azimuth sensor 351b outputs direction information indicating the detected direction. The gyro sensor 351d is a sensor that measures an angular velocity of the second terminal device 30. The gyro sensor 351d outputs angular velocity information indicating the measured angular velocity.

The hand posture measurement unit 352 includes a depth sensor 352a and an infrared camera 352b. The infrared camera 352b outputs infrared light, receives the infrared light reflected from a hand of the user, and captures an image of the hand of the user. Depth sensor 352a measures a distance to the hand of the user on the basis of the image of the hand of the user generated by the infrared camera 352b. The hand posture measurement unit 252 outputs hand posture information including the measured distance to the hand of the user and the image of the hand of the user.

The voice acquisition unit 253 includes a microphone 253a. The microphone 253a collects sounds around the second terminal device 30 and outputs voice information indicating the collected sounds.

The storage unit 310 is implemented by, for example, a semiconductor memory device such as RAM or a flash memory. The storage unit 310 has a function of storing information about processing in the second terminal device 30. In addition, the storage unit 310 stores an application program performed by the second terminal device 30. The application program stored in the storage unit 310 is, for example, a program that causes the worker to visually recognize the first avatar AV1, the reproduction avatar AV3, the 3D map, and the like by using display in VR.

The control unit 300 is implemented by executing an application program stored in the storage unit 310. As illustrated in FIG. 8, the control unit 300 includes a position processing unit 301, a hand posture processing unit 302, a display processing unit 304, a display control unit 305, and a communication control unit 306.

The position processing unit 301 identifies the position, inclination, facing direction, and the like of the head of the user, on the basis of the head information output from the head position measurement unit 351. The hand posture processing unit 302 identifies the position and posture of the hand of the user, on the basis of the hand posture information output from the hand posture measurement unit 352. For example, when a position corresponding to the position of the AR marker in the farm field in the 3D map of the farm field is defined as the origin, the position identified by the position processing unit 301 is identified by a relative position from the origin.

The display processing unit 304 generates images of the virtual hand HL2 and the virtual hand HR2 on the basis of the positions and postures identified by the hand posture processing unit 302. Furthermore, the display processing unit 304 generates an image to be displayed in VR on the basis of the information provided from the information processing apparatus 10. Specifically, the display processing unit 304 generates an image of the first avatar AV1 on the basis of the first avatar information provided from the information processing apparatus 10, and generates the image of the reproduction avatar AV3 on the basis of the reproduction avatar information provided from the information processing apparatus 10. Furthermore, the display processing unit 304 generates an image of the 3D map of the farm field on the basis of the map information provided from the information processing apparatus 10.

The display control unit 305 controls the video output unit 320 so that the image of the first avatar AV1 generated by the display processing unit 304 is displayed in VR, and controls the video output unit 320 so that the image of the reproduction avatar AV3 generated by the display processing unit 304 is displayed in VR. In addition, the display control unit 305 displays the image of the 3D map generated by the display processing unit 304, in VR. The position of the first avatar AV1 displayed in the displayed 3D map is a position corresponding to the position of the user of the first terminal device 20 in the farm field. The position of the reproduction avatar AV3 displayed in the displayed 3D map is a position specified by operating the box BX by the worker or the instructor. In addition, the display control unit 305 controls the video output unit 320 so that the images of the virtual hand HL2 and the virtual hand HR2 are displayed in VR at the positions of the hands identified by the hand posture processing unit 202.

The communication control unit 306 controls the external communication unit 340 to transmit information to the information processing apparatus 10 and receive information from the information processing apparatus 10.

The video output unit 320 displays a VR image output from the control unit 300 to cause the worker to visually recognize the VR image. The voice output unit 330 includes a speaker and outputs a sound represented by a voice signal supplied from the external device. The external communication unit 340 has a function of communicating with the external device. For example, in communication with the external device, the external communication unit 340 supplies information received from the external device to the control unit 300. Specifically, the external communication unit 340 supplies the first avatar information, reproduction avatar information, and map information received from the information processing apparatus 10 to the control unit 300. Furthermore, in communication with the external device, the external communication unit 340 transmits information supplied from the control unit 300, to the external device. Specifically, the external communication unit 340 transmits the second posture information including the head information and the hand posture information, to the information processing apparatus 10.

### 3.4. Process in Information Processing System

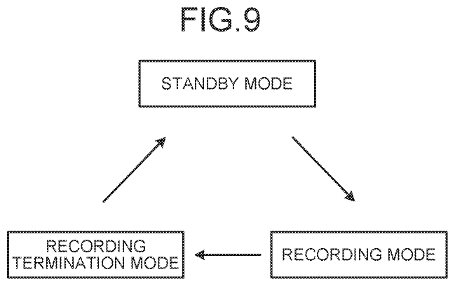

Next, a process performed in the information processing system 1 will be described. FIG. 9 is a state transition diagram of the first terminal device 20 recording the motion of the user thereof. The first terminal device 20 transitions to any of a standby mode, a recording mode, and a recording termination mode in recording the motion of the user. The standby mode is a state in which the motion of the user is recordable. When it is detected that the tap operation is performed a predetermined number of times with a period less than the predetermined period in the standby mode, the first terminal device 20 transitions to the recording mode.

The recording mode is a mode of recording data about the position and posture of each hand of the user and the position and posture of the head of the user. When it is detected that the tap operation is performed a predetermined number of times with a period less than the predetermined period in the recording mode, the first terminal device 20 transitions to the recording termination mode.

The recording termination mode is a mode in which recording the data about the position and posture of the hand of the instructor and the position and posture of the head of the instructor is finished to store the motion data. In the recording termination mode, the first terminal device 20 deletes data related to the tap operation from the recorded data, and stores data related to the motion other than the tap operation, in the storage unit 210, as the motion data. When the storage of the motion data in the storage unit 210 is finished, the first terminal device 20 transitions to the standby mode.

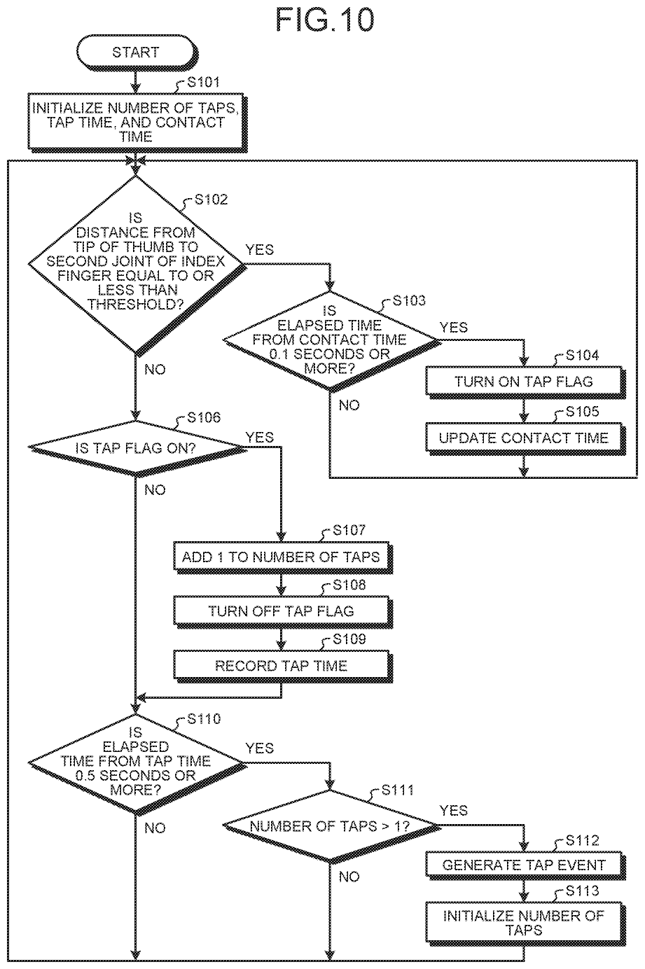

FIG. 10 is a flowchart illustrating a process of detecting the tap operation by the first terminal device 20. In the process of detecting the tap operation, the first terminal device 20 first initializes the number of taps, the tap time, and the contact time (Step S101). Specifically, the number of taps is set to 0, recording the tap time and contact time as the time at which the number of taps is set to 0.

The first terminal device 20 determines whether the distance from the tip of the thumb of the user to the second joint of the index finger is equal to or less than the threshold, on the basis of the hand posture information output from the hand posture measurement unit 252 (Step S102). When the distance from the tip of the thumb of the user to the second joint of the index finger is equal to or less than the threshold (Yes in Step S102), the first terminal device 20 determines whether an elapsed time from the recorded contact time is 0.1 seconds or more (Step S103). When the elapsed time from the recorded contact time is 0.1 seconds or more (Yes in Step S103), the first terminal device 20 turns on a tap flag (Step S104) and updates the recorded contact time to the time at which the tap flag is turned on (Step S105). When the elapsed time from the recorded contact time is less than 0.1 seconds (No in Step S103) or when the processing of Step S105 is finished, the first terminal device 20 returns the process to Step S102.

When the distance from the tip of the thumb of the user to the second joint of the index finger exceeds the threshold (No in Step S102), the first terminal device 20 determines whether the tap flag is on (Step S106). When the tap flag is on (Yes in Step S106), the first terminal device 20 adds 1 to the recorded number of taps (Step S107). Next, the first terminal device 20 turns off the tap flag (Step S108), and updates the recorded tap time to the time at which the tap flag is turned off (Step S109).

When the tap flag is off (No in Step S106) or when the processing in Step S109 is finished, the first terminal device 20 advances the process to Step S110. The first terminal device 20 determines whether the elapsed time from the recorded tap time is 0.5 seconds or more (Step S110). When the elapsed time from the recorded tap time is 0.5 seconds or more (Yes in Step S110), the first terminal device 20 determines whether the recorded number of taps exceeds 1 (Step S111). When the recorded number of taps exceeds 1 (Yes in Step S111), the first terminal device 20 generates a tap event including the recorded number of taps (Step S112), and initializes the recorded number of taps to 0 (Step S113).

When the elapsed time from the recorded tap time is less than 0.5 seconds (No in Step S11), when the recorded number of taps is 1 or less (No in Step S111), or when the processing of Step S113 is finished, the first terminal device 20 returns the process to Step S102. According to the process of FIG. 10, in the first terminal device 20, the tap event occurs when the tap operation is performed twice or more with a period of less than 0.5 seconds.

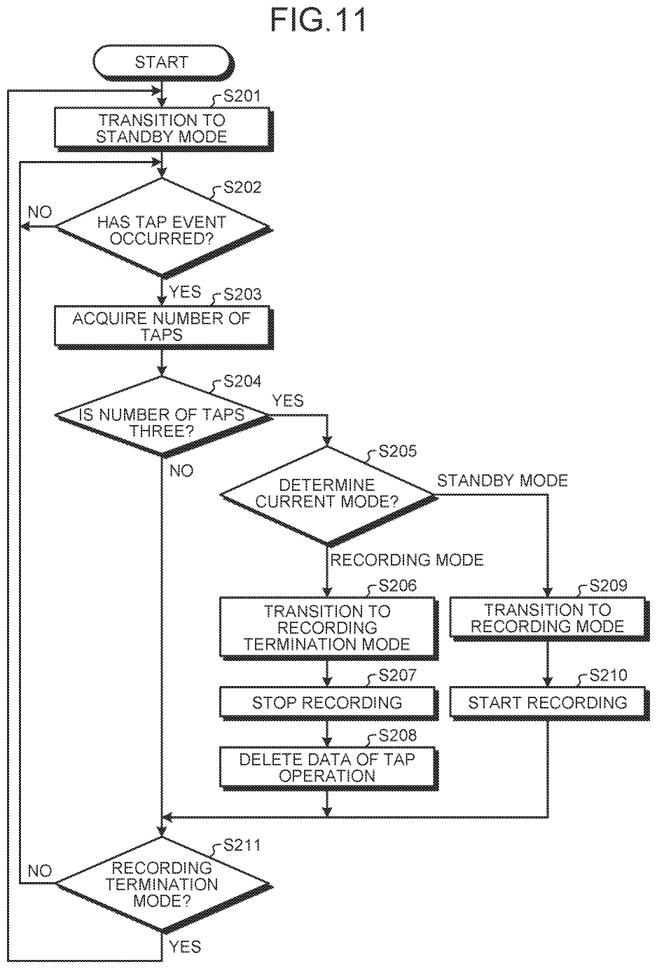

FIG. 11 is a flowchart illustrating a process of recording the motion of the user by the first terminal device 20. First, the first terminal device 20 transitions to the standby mode (Step S201). Next, the first terminal device 20 determines whether the tap event has occurred (Step S202). When no tap event has occurred in the process of FIG. 10 (No in Step S202), the first terminal device 20 repeats the processing of Step S202 until the tap event occurs.

When the tap event has occurred (Yes in Step S202), the first terminal device 20 acquires the number of taps included in the tap event having occurred in the process of FIG. 10 (Step S203). The first terminal device 20 determines whether the acquired number of taps is three or more (Step S204). When the acquired number of taps is three or more (Yes in Step S204), the first terminal device 20 determines the operation mode at this time (Step S205). Note that the number of taps determined here is not limited to three, and may be two or four or more.

When the mode at this time is the standby mode (standby mode in Step S205), the first terminal device 20 transitions to the recording mode (Step S209), and starts recording of data about the position and posture of each hand of the instructor and the position and posture of the head of the instructor (Step S210).

On the other hand, when the mode is the recording mode (recording mode in Step S205), the first terminal device 20 transitions to the recording termination mode (Step S206), and stops recording of the data about the position and posture of the hand of the instructor and the position and posture of the head of the instructor (Step S207). Next, the first terminal device 20 deletes data related to the tap operation from the recorded data (Step S208). The data from which the tap operation has been deleted is stored in the storage unit 210, as the motion data. The motion data stored in the storage unit 210 is transmitted to the information processing apparatus 10.

When it is determined as No in Step S204, when the processing in Step S208 is finished, or when the processing in Step S210 is finished, the first terminal device 20 determines whether the mode is the recording termination mode (Step S211). When the mode is the recording termination mode (Yes in Step S211), the first terminal device 20 returns the process to Step S201, and when the mode is not the recording termination mode (No in Step S211), the first terminal device 20 returns the process to Step S202.

According to the process illustrated in FIG. 11, when the instructor wears the first terminal device 20 and performs the tap operation, the position and posture of the hand of the instructor, the position and posture of the head of the instructor, and the like can be recorded as a model motion of work in the farm field.

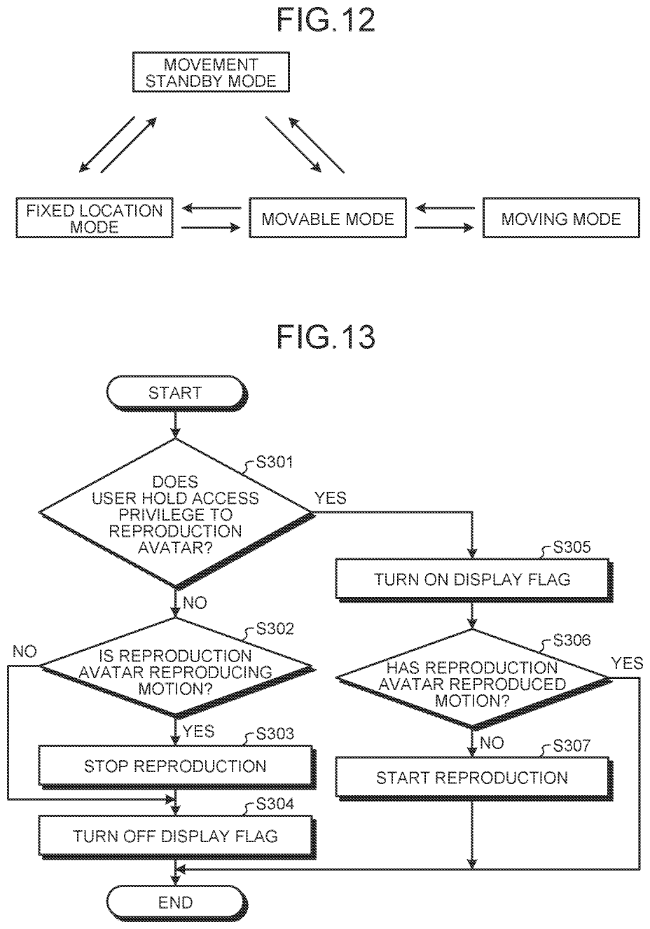

FIG. 12 is a state transition diagram related to moving the reproduction avatar AV3. In moving the reproduction avatar AV3, the information processing apparatus 10 transitions to any of a fixed location mode, a movement standby mode, a movable mode, and a moving mode.

The movement standby mode is a mode of reproduction of the motion data by the reproduction avatar AV3 at a position specified by the user. In the movement standby mode, the reproduction avatar AV3 reproduces the motion of the head and motion of the hands indicated by the motion data.

The fixed location mode is a mode of reproducing the motion data by the reproduction avatar AV3 at a position at which the user has recorded the motion data. For example, when the position of an AR marker set at a predetermined position in the farm field is defined as the origin, the position where the motion data has been recorded is a relative position from the origin upon recording of the motion data.

The movable mode is a mode of stopping the reproduction of the motion data upon approach of any of the virtual hand HL1, virtual hand HR1, virtual hand HL2, or virtual hand HR2 to the box BX included in the reproduction avatar AV3.

The moving mode is a mode in which the user can operate the box BX to move the position of the reproduction avatar AV3.

Note that in the movable mode or the moving mode, the reproduction of the motion data by the reproduction avatar AV3 may be stopped, and only the head and body of the avatar may be displayed. Note that in the movable mode, moving image data may be reproduced.

### 3.5. Variations of Processing

The display of the reproduction avatar AV3 may be controlled according to an access privilege of the user to the reproduction avatar AV3. FIG. 13 is a flowchart illustrating a process in changing the access privilege to the reproduction avatar AV3, for the user of the first terminal device 20 and the user of the second terminal device 30. In order to display the reproduction avatar AV3, the information processing apparatus 10 first determines whether each user holds the access privilege to the reproduction avatar AV3 (Step S301). When the user does not hold the access privilege to the reproduction avatar AV3 (No in Step S301), the information processing apparatus 10 determines whether the reproduction avatar AV3 is reproducing the motion data (Step S302). When the reproduction avatar AV3 is reproducing the motion data (Yes in Step S302), the information processing apparatus 10 stops the reproduction of the motion data by the reproduction avatar AV3 (Step S303) and turns off a display flag of the reproduction avatar AV3 for the user (Step S304).

For example, when the access privilege to the reproduction avatar AV3 is changed for the worker and the access privilege is revoked, the display flag for the worker is turned off by performing the processing of Steps S301 to S304. When the worker is wearing the first terminal device 20, the information processing apparatus 10 stops the transmission of the reproduction avatar information to the first terminal device 20 is stopped, because the display flag for the worker is off. The transmission of the reproduction avatar information to the first terminal device 20 is stopped, and thereby the reproduction avatar AV3 is not displayed in AR on the first terminal device 20.

When the user holds the access privilege to the reproduction avatar AV3 (Yes in Step S301), the information processing apparatus 10 turns on the display flag of the reproduction avatar AV3 for the user (Step S305). The information processing apparatus 10 determines whether the reproduction avatar AV3 has reproduced the motion data (Step S306). When the reproduction avatar AV3 has not reproduced the motion data (No in Step S306), the information processing apparatus 10 starts reproducing the motion data by the reproduction avatar AV3 (Step S307).

For example, when the access privilege to the reproduction avatar AV3 is changed for the worker and the access privilege is given, the display flag for the worker is turned on by performing the processing of Steps S305 to S307. When the worker is wearing the first terminal device 20, the information processing apparatus 10 transmits the reproduction avatar information to the first terminal device 20, because the display flag for the worker is on. The transmission of the reproduction avatar information to the first terminal device 20 is performed, and thereby the reproduction avatar AV3 is displayed in AR in the first terminal device 20.

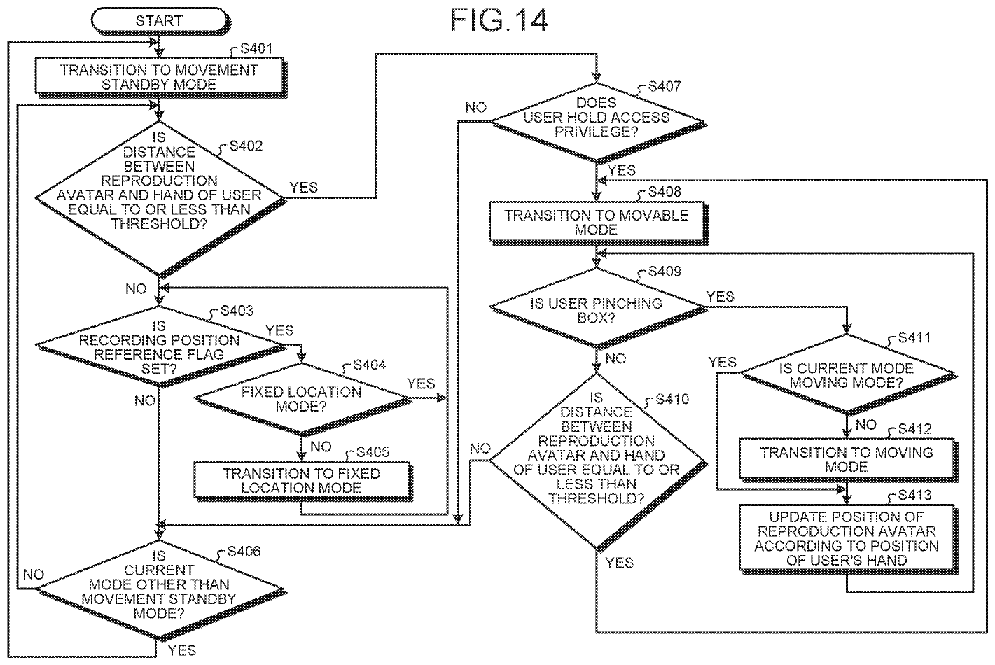

Note that, when the access privilege to the reproduction avatar AV3 is set for the user, moving the reproduction avatar AV3 may be controlled according to the access privilege. FIG. 14 is a flowchart illustrating a process of moving the reproduction avatar AV3, with the access privilege to the reproduction avatar AV3 set for the user.

In the process of FIG. 14, when moving the display position of the reproduction avatar AV3, the information processing apparatus 10 transitions to the movement standby mode first (Step S401). The information processing apparatus 10 determines whether a distance between the reproduction avatar AV3 and a hand of the user is equal to or less than a threshold (Step S402). When the distance between the reproduction avatar AV3 and the hand of the user is not equal to or less than the threshold (No in Step S402), the information processing apparatus 10 determines whether a recording position reference flag is set (Step S403). The recording position reference flag is a flag that indicates whether the position where the user has recorded the motion data is stored.

When the recording position reference flag is set, the information processing apparatus 10 determines whether the mode is the fixed location mode (Step S404). When the mode is the fixed location mode (Yes in Step S404), the information processing apparatus 10 returns the process to Step S403, and when the mode is not the fixed location mode (No in Step S404), the information processing apparatus 10 transitions to the fixed location mode and returns the process to Step S403.

When no recording position reference flag is set (No in Step S403), the information processing apparatus 10 determines whether the current mode is the movement standby mode (Step S406). When the current mode is the movement standby mode (Yes in Step S406), the information processing apparatus 10 returns the process to Step S401, and when the current mode is not the movement standby mode (No in Step S406), the information processing apparatus 10 returns the process to Step S402.

When the distance between the reproduction avatar AV3 and the hand of the user is equal to or less than the threshold (Yes in Step S402), the information processing apparatus 10 determines whether the user whose distance between the reproduction avatar AV3 and the hand is equal to or less than the threshold has the access privilege to the reproduction avatar AV3 (Step S407). When the user does not have the access privilege (No in Step S407), the information processing apparatus 10 advances the process to Step S406.

When the user has the access privilege (Yes in Step S407), the information processing apparatus 10 transitions to the movable mode (Step S408). After transitioning to the movable mode, the information processing apparatus 10 determines whether the user is pinching the box BX (Step S409). When the user pinches the box BX (Yes in Step S409), the information processing apparatus 10 determines whether the current mode is the moving mode (Step S411). When the current mode is not the moving mode (No in Step S411), the information processing apparatus 10 transitions to the moving mode (Step S412). When the current mode is the moving mode (Yes in Step S411) or when the processing of Step S412 is finished, the information processing apparatus 10 updates the position of the reproduction avatar AV3 according to the position of the hand of the user (Step S413).

When the user is not pinching the box BX (No in Step S409), the information processing apparatus 10 determines whether the distance between the reproduction avatar AV3 and the hand of the user is equal to or less than the threshold (Step S410). When the distance between the reproduction avatar AV3 and the hand of the user is not equal to or less than the threshold (No in Step S410), the information processing apparatus advances the process to Step S406, and when the distance between the reproduction avatar AV3 and the hand of the user is equal to or less than the threshold (Yes in Step S402), the information processing apparatus 10 advances the process to Step S408.

Although the embodiments described above have a configuration for performing display in AR and display in VR supporting Synecoculture, the display in AR and the display in VR displayed by the information processing system 1 are not limited to those supporting Synecoculture, and for example, display in AR and display in VR may be compatible with work in a factory or work at a construction site.

In the embodiments described above, a face photograph of the user of the first terminal device 20 may be combined with the first avatar AV1, and a face photograph of the user of the second terminal device 30 may be combined with the second avatar AV2.

In the embodiments described above, in a case where the plurality of first terminal devices 20 is connected to the information processing apparatus 10, the first avatars AV1 of a plurality of the users wearing the first terminal devices 20 may be displayed. Furthermore, in a case where the plurality of second terminal devices 30 is connected to the information processing apparatus 10, the second avatars AV2 of a plurality of the users wearing the second terminal devices 30 may be displayed. Furthermore, in the embodiments described above, the information processing apparatus 10 may store a plurality of pieces of motion data, displaying the reproduction avatar AV3 for each of the plurality of pieces of motion data selected from the stored motion data.

In the embodiments described above, the second terminal device 30 may include the depth sensor, the SLAM, and the GPS module included in the first terminal device 20. Furthermore, similarly to the first terminal device 20, the second terminal device 30 may include the motion recording unit. According to this configuration, for example, the instructor records the motion at the remote location, and the worker can view, in the farm field, the motion recorded at the remote location through the reproduction avatar AV3. With this configuration, the instructor can record a motion as a model eve if the instructor does not go to the farm field.

In the embodiment described above, the user of the first terminal device 20 is the worker and the user of the second terminal device 30 is the instructor, but the user of the first terminal device 20 in the farm field may be the instructor, and the user of the second terminal device 30 in the remote location may be the worker. In this case, the instructor records the motion in the farm field as described above, and the worker can view the recorded motion through the reproduction avatar AV3 from the remote location. Viewing the motion of the reproduction avatar AV3 arranged in the virtual space on the second terminal device 30, the worker can view the motion as a model and work in the farm on the basis of the motion that the worker has viewed.

### 4. EXEMPLARY HARDWARE CONFIGURATION

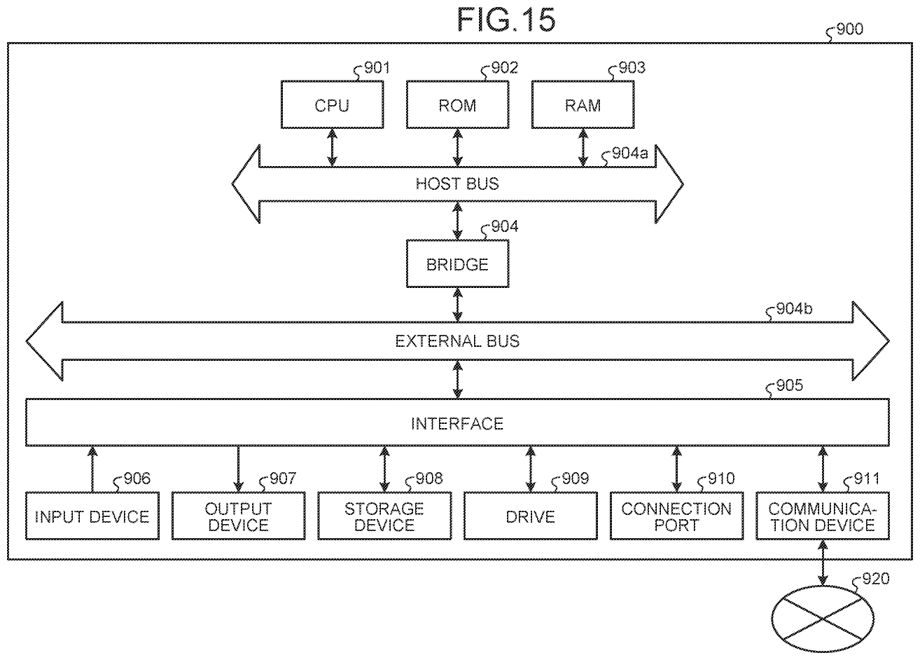

Next, an exemplary hardware configuration of the information processing apparatus according to an embodiment will be described with reference to FIG. 15. FIG. 15 is a block diagram illustrating an exemplary hardware configuration of a computer implementing the functions of the information processing apparatus according to an embodiment. Note that an information processing apparatus 900 illustrated in FIG. 15 can implement, for example, the information processing apparatus 10, first terminal device 20, and second terminal device 30 illustrated in FIG. 1. Information processing by the information processing apparatus 10, first terminal device 20, and second terminal device 30 according to the embodiment is implemented by cooperation between software and hardware which is described below.

As illustrated in FIG. 15, the information processing apparatus 900 includes a central processing unit (CPU) 901, a read only memory (ROM) 902, and a random access memory (RAM) 903. Furthermore, the information processing apparatus 900 includes a host bus 904a, a bridge 904, an external bus 904b, an interface 905, an input device 906, an output device 907, a storage device 908, a drive 909, a connection port 910, and a communication device 911. Note that the hardware configuration described here is merely an example, and some of the component elements may be omitted. In addition, a component element other than the component elements described here may be further included.

The CPU 901 functions as, for example, an arithmetic processing device or a control device, and controls all or some of the operations of the component elements on the basis of various computer programs recorded in the ROM 902, the RAM 903, or the storage device 908. The ROM 902 is a unit that stores a program read by the CPU 901, data used for calculation, and the like. The RAM 903 temporarily or permanently stores, for example, a program read by the CPU 901, various parameters appropriately changing upon running the program, and the like. The CPU 901, the ROM 902, and the RAM 903 are mutually connected by the host bus 904a including a CPU bus or the like. The CPU 901, the ROM 902, and the RAM 903 can implement the functions of the control unit 100, control unit 200, and control unit 300 which have been described with reference to FIGS. 6 to 8, for example, in cooperation with the software.

The CPU 901, the ROM 902, and the RAM 903 are mutually connected, for example, via the host bus 904a configured to transmit data at high speed. Meanwhile, the host bus 904a is connected to the external bus 904b configured to transmit data at relatively low speed, for example, via the bridge 904. In addition, the external bus 904b is connected to various component elements via the interface 905.

The input device 906 is implemented by a device, such as a mouse, keyboard, touch screen, button, microphone, switch, and lever, into which information is input. Furthermore, the input device 906 may be a remote-control device using, for example, an infrared ray or another radio wave, or may be an external connection device, such as a mobile phone or PDA, that is compatible with the operation of the information processing apparatus 900. Furthermore, the input device 906 may include, for example, an input control circuit or the like that generates an input signal on the basis of information input using the input means described above and that outputs the input signal to the CPU 901. The user of the information processing apparatus 900 can operate the input device 906 to input various data to the information processing apparatus 900 or give the information processing apparatus 900 an instruction to perform processing operation.

In addition, the input device 906 can include a device that detects the position of the user. For example, the input device 906 can include various sensors, such as an image sensor (e.g., camera), depth sensor (e.g., stereo camera), acceleration sensor, gyro sensor, geomagnetic sensor, optical sensor, sound sensor, distance measurement sensor (e.g., time of flight (ToF) sensor), and force sensor. Furthermore, the input device 906 may acquire information about a state of the information processing apparatus 900 itself, such as the attitude and movement speed of the information processing apparatus 900, and information about a space around the information processing apparatus 900, such as brightness and noise around the information processing apparatus 900. Furthermore, the input device 906 may include a GNSS module that receives a GNSS signal (e.g., GPS signal from a global positioning system (GPS) satellite) from a global navigation satellite system (GNSS) satellite and that measures position information including the latitude, longitude, and altitude of the device. Furthermore, for the position information, the input device 906 may detect the position by transmission and reception with Wi-Fi (registered trademark), a mobile phone, PHS, smartphone, or the like, near field communication, or the like. The input device 906 can implement the function of, for example, the sensor unit 250 described with reference to FIG. 7 and the function of the sensor unit 350 described with reference to FIG. 8.

The output device 907 includes a device configured to visually or audibly notify the user of information acquired. Examples of such a device include a display device such as a CRT display device, liquid crystal display device, plasma display device, EL display device, laser projector, LED projector, and lamp, an acoustic output device such as a speaker and headphones, a printer device, and the like. The output device 907 outputs results obtained from, for example, various processing performed by the information processing apparatus 900. Specifically, the display device visually displays the results obtained from various processing performed by the information processing apparatus 900, in various formats such as text, image, table, and graph. Meanwhile, the sound output device converts an audio signal including voice data, acoustic data, or the like reproduced, into an analog signal, and aurally outputs the analog signal. The output device 907 can implement the functions of, for example, the video output unit 220 and voice output unit 230 described with reference to FIG. 7 and the functions of the video output unit 320 and voice output unit 330 described with reference to FIG. 8.

The storage device 908 is a data storage device that is formed as an example of a storage unit of the information processing apparatus 900. The storage device 908 is implemented by, for example, a magnetic storage device such as HDD, a semiconductor storage device, an optical storage device, a magneto-optical device, or the like. The storage device 908 may include a storage medium, a recording device that records data in the storage medium, a reading device that reads data from the storage medium, a deletion device that deletes data recorded in the storage medium, and the like. The storage device 908 stores the programs and various data used for the CPU 901, various data acquired from outside, and the like. The storage device 908 can implement the functions of, for example, the storage unit 120, storage unit 210, and storage unit 310 described with reference to FIGS. 6 to 8.

The drive 909 is a storage medium reader/writer, and is built in or externally mounted to the information processing apparatus 900. The drive 909 reads information recorded in a removable storage medium mounted, such as a magnetic disk, optical disk, magneto-optical disk, or semiconductor memory, and outputs the information to the RAM 903. In addition, the drive 909 is configured to write information on the removable storage medium.

The connection port 910 is, for example, a port for connecting an external connection device, such as a universal serial bus (USB) port, IEEE1394 port, small computer system interface (SCSI), RS-232C port, or optical audio terminal. The communication device 911 is a communication interface that includes, for example, a communication device or the like for connection to a communication network 920. The communication device 911 is a communication card or the like, such as for a wired or wireless local area network (LAN), long term evolution (LTE), Bluetooth (registered trademark), or wireless USB (WUSB). Furthermore, the communication device 911 may be a router for optical communication, a router for an asymmetric digital subscriber line (ADSL), a modem for various communications, or the like. The communication device 911 is configured to transmit/receive a signal or the like between, for example, the Internet or another communication device according to a predetermined protocol such as TCP/IP. The communication device 911 can implement the functions of, for example, the communication unit 110, external communication unit 240, and external communication unit 340 described with reference to FIGS. 6 to 8.

Note that the communication network 920 is a wired or wireless transmission path for information transmitted from devices connected to the communication network 920. For example, the communication network 920 may include a public network such as the Internet, a telephone network, or a satellite communication network, various local area networks (LANs) including Ethernet (registered trademark), a wide area network (WAN), or the like. Furthermore, the communication network 920 may include a private network such as an Internet protocol-virtual private network (IP-VPN).

An example of the hardware configuration capable of implementing the functions of the information processing apparatus 900 according to an embodiment has been described above. Each of the component elements described above may be implemented using a general-purpose member, or may be implemented using hardware dedicated to the function of each component element. Accordingly, the hardware configuration to be used can be changed as appropriate according to the technical level when the present embodiment is carried out.

### 5. CONCLUSION

As described above, according to the information processing system 1, both of the worker and the instructor can view the avatars that reproduce the motions of the users, for efficient assistance to the work. Furthermore, according to the information processing system 1, the position and direction of the reproduction avatar AV3 can be changed, and therefore, the reproduction avatar AV3 can be viewed from multiple points of view. Therefore, the motion can be readily understood, leading to efficient assistance. Furthermore, according to the information processing system 1, the motion data is stored, with the data related to the tap operation that triggers the finish of recording the motion deleted. Therefore, only the motion necessary for assistance can be stored as the motion data.

Note that the present technology can also have the following configurations.

(1)

An information processing apparatus comprising:
an acquisition unit that acquires first posture information indicating positions and postures of one or more first users each wearing a first terminal device, and second posture information indicating positions and postures of one or more second users each wearing a second terminal device;
a storage unit that stores motion data indicating a change in posture of each user;
a processing unit that arranges first avatars of the one or more first users in a virtual space based on the first posture information, arranges second avatars of the one or more second users in the virtual space based on the second posture information, and arranges a reproduction avatar being changeable in position and direction and reproducing the motion data in the virtual space; and
an output unit that causes the first terminal device to display the second avatar and the reproduction avatar according to positions in the virtual space, and causes the second terminal device to display the first avatar and the reproduction avatar according to positions in the virtual space.
   (2)

The information processing apparatus according to (1), wherein
the processing unit changes the direction of the reproduction avatar according to a predetermined motion of the first user or the second user.
   (3)

The information processing apparatus according to (1) or (2), wherein
the processing unit enables only a predetermined user to change the position and direction of the reproduction avatar.
   (4)

The information processing apparatus according to any one of (1) to (3), wherein
recording of the motion data is started and stopped according to a predetermined motion of a user.
   (5)

The information processing apparatus according to (4), wherein
the motion data is data from which the predetermined motion is deleted.
   (6)

The information processing apparatus according to (4), wherein
the predetermined motion is a motion of a hand of a user.
   (7)

The information processing apparatus according to any one of (1) to (6), wherein
the first terminal device performs display in AR, and
the second terminal device performs display in VR.
   (8)

The information processing apparatus according to any one of (1) to (7), wherein
the first terminal device is worn by a worker, and
the second terminal device is worn by an instructor who assists the worker.
   (9)

The information processing apparatus according to any one of (1) to (8), wherein
a picture of the first user is combined with the first avatar, and
a picture of the second user is combined with the second avatar.
   (10)

An information processing method comprising:
an acquisition step of acquiring first posture information indicating positions and postures of one or more first users each wearing a first terminal device, and second posture information indicating positions and postures of one or more second users each wearing a second terminal device;
a storage step of storing motion data indicating a change in posture of each user;
a processing step of arranging first avatars of the one or more first users in a virtual space based on the first posture information, arranging second avatars of the one or more second users in the virtual space based on the second posture information, and arranging a reproduction avatar being changeable in position and direction and reproducing the motion data in the virtual space; and
an output step of causing the first terminal device to display the second avatar and the reproduction avatar according to positions in the virtual space, and causes the second terminal device to display the first avatar and the reproduction avatar according to positions in the virtual space.
   (11)

A program causing
a computer to perform:
an acquisition step of acquiring first posture information indicating positions and postures of one or more first users each wearing a first terminal device, and second posture information indicating positions and postures of one or more second users each wearing a second terminal device;
a storage step of storing motion data indicating a change in posture of each user;
a processing step of arranging first avatars of the one or more first users in a virtual space based on the first posture information, arranging second avatars of the one or more second users in the virtual space based on the second posture information, and arranging a reproduction avatar being changeable in position and direction and reproducing the motion data in the virtual space; and
an output step of causing the first terminal device to display the second avatar and the reproduction avatar according to positions in the virtual space, and causes the second terminal device to display the first avatar and the reproduction avatar according to positions in the virtual space.

### REFERENCE SIGNS LIST

1 INFORMATION PROCESSING SYSTEM
10 INFORMATION PROCESSING APPARATUS
20 FIRST TERMINAL DEVICE
30 SECOND TERMINAL DEVICE
100 CONTROL UNIT
101 ACQUISITION UNIT
102 PROCESSING UNIT
1021 POSITION/POSTURE IDENTIFICATION UNIT
1022 GENERATION UNIT
103 OUTPUT UNIT
110 COMMUNICATION UNIT
120 STORAGE UNIT
200, 300 CONTROL UNIT
201, 301 POSITION PROCESSING UNIT
202, 302 HAND POSTURE PROCESSING UNIT
203 MOTION RECORDING UNIT
204, 304 DISPLAY PROCESSING UNIT
205, 305 DISPLAY CONTROL UNIT
206, 306 COMMUNICATION CONTROL UNIT
210, 310 STORAGE UNIT
220, 320 VIDEO OUTPUT UNIT
230, 330 VOICE OUTPUT UNIT
240, 340 EXTERNAL COMMUNICATION UNIT
250, 350 SENSOR UNIT
251, 351 HEAD POSITION MEASUREMENT UNIT
252, 352 HAND POSTURE MEASUREMENT UNIT
253, 353 VOICE ACQUISITION UNIT
AV1 FIRST AVATAR
AV2 SECOND AVATAR
AV3 REPRODUCTION AVATAR

1. An information processing apparatus comprising:
an acquisition unit that acquires first posture information indicating positions and postures of one or more first users each wearing a first terminal device, and second posture information indicating positions and postures of one or more second users each wearing a second terminal device;
a storage unit that stores motion data indicating a change in posture of each user;
a processing unit that arranges first avatars of the one or more first users in a virtual space based on the first posture information, arranges second avatars of the one or more second users in the virtual space based on the second posture information, and arranges a reproduction avatar being changeable in position and direction and reproducing the motion data in the virtual space; and
an output unit that causes the first terminal device to display the second avatar and the reproduction avatar according to positions in the virtual space, and causes the second terminal device to display the first avatar and the reproduction avatar according to positions in the virtual space.

2. The information processing apparatus according to claim 1, wherein
the processing unit changes the direction of the reproduction avatar according to a predetermined motion of the first user or the second user.

3. The information processing apparatus according to claim 1, wherein
the processing unit enables only a predetermined user to change the position and direction of the reproduction avatar.

4. The information processing apparatus according to claim 1, wherein
recording of the motion data is started and stopped according to a predetermined motion of a user.

5. The information processing apparatus according to claim 4, wherein
the motion data is data from which the predetermined motion is deleted.

6. The information processing apparatus according to claim 4, wherein
the predetermined motion is a motion of a hand of a user.

7. The information processing apparatus according to claim 1, wherein
the first terminal device performs display in AR, and
the second terminal device performs display in VR.

8. The information processing apparatus according to claim 1, wherein
the first terminal device is worn by a worker, and
the second terminal device is worn by an instructor who assists the worker.

9. The information processing apparatus according to claim 1, wherein
a picture of the first user is combined with the first avatar, and
a picture of the second user is combined with the second avatar.

10. An information processing method comprising:
an acquisition step of acquiring first posture information indicating positions and postures of one or more first users each wearing a first terminal device, and second posture information indicating positions and postures of one or more second users each wearing a second terminal device;
a storage step of storing motion data indicating a change in posture of each user;
a processing step of arranging first avatars of the one or more first users in a virtual space based on the first posture information, arranging second avatars of the one or more second users in the virtual space based on the second posture information, and arranging a reproduction avatar being changeable in position and direction and reproducing the motion data in the virtual space; and
an output step of causing the first terminal device to display the second avatar and the reproduction avatar according to positions in the virtual space, and causes the second terminal device to display the first avatar and the reproduction avatar according to positions in the virtual space.

11. A program causing
a computer to perform:
an acquisition step of acquiring first posture information indicating positions and postures of one or more first users each wearing a first terminal device, and second posture information indicating positions and postures of one or more second users each wearing a second terminal device;
a storage step of storing motion data indicating a change in posture of each user;
a processing step of arranging first avatars of the one or more first users in a virtual space based on the first posture information, arranging second avatars of the one or more second users in the virtual space based on the second posture information, and arranging a reproduction avatar being changeable in position and direction and reproducing the motion data in the virtual space; and
an output step of causing the first terminal device to display the second avatar and the reproduction avatar according to positions in the virtual space, and causes the second terminal device to display the first avatar and the reproduction avatar according to positions in the virtual space.
